(19) United States
(12) Patent Application Publication
(10) Pub. No.: US 2015/0200438 A1
(43) Pub. Date: Jul. 16, 2015

(54) METHOD AND APPARATUS FOR A DISPERSIVE MICROWAVE GROUP DELAY LINE

(71) Applicants: Ching-Wen HSUE, Taichung City (TW); Thomas HSUE, Taichung City (TW)

(72) Inventors: Ching-Wen HSUE, Taichung City (TW); Thomas HSUE, Taichung City (TW)

(21) Appl. No.: 14/156,348

(22) Filed: Jan. 15, 2014

(51) Int. Cl. H01P 9/00; H01P 3/08

(52) U.S. Cl. CPC H01P 9/00; H01P 3/081

(57) ABSTRACT

A basic cell of a microwave group delay line is disclosed for tuning the electromagnetic signal propagation delay time from signal source (1) to output (5), wherein two pairs of unequal-length stubs ((L_{1b}, L_{1b}), (L_{2b}, L_{2b})) are placed on both sides of the main transmission path (2) in the signal layer and two pairs of complementary slot-lines ((L₁ₜ, L₁ₜ), (L₂ₜ, L₂ₜ)) are placed on both sides of the main transmission path (2) in ground plane for microstrip structure. Unequal-length stubs are placed in central layer and complementary slot-lines are placed in either outer conductor ground planes for strip-line structure. The characteristic impedances (Z₀, 2Z_{1b}, 2Z_{2b}, 2Z₁ₜ, 2Z₂ₜ) of transmission paths are selected to control group delay time and minimize reflection of signals from signal source to output. A cascade connection of the basic cell forms a delay line system.

### BACKGROUND OF THE INVENTION

1. Field of the Invention

This invention relates to a technique for implementing a dispersive group delay line for the electromagnetic signal.

2. Description of the Related Art

Group delay has been a subject of interest in electromagnetic communications, wherein the transmission paths are required to have flat group delay in the pass-bands. For example, a band-pass filter based on conventional Chebyshev, Butterworth or elliptic method has a flat group delay in the pass-band and it has larger group delay near the edges of the pass-band. However, the larger group delay response outside of the pass-band is of no particular consequence in most cases. As a result, most of efforts focused on the flat group delay in the microwave components study. Unfortunately, electromagnetic communication channels suffer strong group delay variation in air or other transmission paths and the time domain waveforms become distorted when impulse signals are considered. The group delay line can be used to tame the distortion effect.

Dispersive delay lines using conventional all-pass technology experience small group delay time. A cascade connection of all-pass delay units improves the overall response in the sense of obtaining larger group delay time. However, it increases the circuit area as well as transmission losses. Although the surface acoustic wave devices are compact and provide large delays, their applications are limited to low-frequency and narrow-bandwidth applications. Therefore, there is a need for a technique for implementing a group delay line with larger frequency-sensitive delay time, low-loss response for wide-bandwidth applications.

### SUMMARY OF THE INVENTION

Briefly, in accordance with the invention, a group-delay network is provided for tuning the propagation delay time of designated signal frequencies from the source to the output load. The basic cell of the group delay device comprises a main transmission path that is connected to source and output at two ends, a couple of pairs of unequal-length, parallel, open stubs, a couple of pairs of complementary slot lines. The pairs of unequal-length, parallel stubs are directly connected to the main transmission path, wherein one pair of stubs are different from another pair of stubs in the sense of electric length θᵢ (i=1, 2). In other words, two electric (and physical) lengths of stubs are different from each other, as shown in FIG. 1, and θ₁≠θ₂. The pair of stubs (2Z_{1b}, 2Z_{1b}) is referred to as unequal in length to the pair of stubs (2Z_{2b}, 2Z_{2b}). Two pairs of complementary slot lines are corresponding to the characteristics of two pairs of unequal-length, open stubs, respectively, which are omitted in FIG. 1. Z_{S} and Z_{L} in FIG. 1 are source and load impedances, respectively. Two pairs of unequal-length, parallel stubs are employed to generate an induced pass-band lying between two stop-bands. The maximum transmission coefficient in the induced pass-band, which is bounded by two transmission nulls in the frequency band, is determined by the following relationship

Z_{1b} cot θ₁+Z_{2b} cot θ₂=0 (1)

The maximum group delay G_{d} in the induced pass-band is

$${G}_{d} \approx 2 {T}_{o} \frac{{Z}_{o}}{{Z}_{1 b} {Z}_{2 b} / ( {Z}_{1 b} + {Z}_{2 b} )} \frac{1}{{δ}_{o}^{2}} , \qquad ( 2 )$$

where T₀ is the propagation delay time for the signal traveling across one of unequal-length stubs, and δ₀ is the normalized bandwidth of the induced pass-band.
In a preferred embodiment, the group delay is determined the propagation delay time of each unequal-length stubs, the normalized induced pass-band band-width and characteristic impedances of both main transmission path and unequal-length stubs.

In applications where group delays of certain bands of high-frequency signals are to be tuned, the present invention can be realized on a printed circuit board. For the main transmission path and two pairs of unequal-length, parallel stubs, each element is fabricated in changing the conductor strip width and length of the element. For the complementary slot line, the conductor is removed from the ground conductor plane to form the strip-like non-conductor strip. The complementary slot line is placed just beneath the corresponding stub, and the stub is separated from the complementary slot line with the insulating dielectric substrate.

### BRIEF SUMMARY OF THE DRAWINGS

FIG. 1 shows the equivalent transmission line representation of the basic cell of a group delay line.

FIG. 2 shows a schematic drawing of unequal-length stubs of basic cell in the top signal layer.

FIG. 3 shows a schematic drawing of unequal-length complementary slot lines of basic cell in the bottom ground layer.

FIG. 4 shows a three-dimension schematic drawing of basic cell of a group delay line.

FIG. 5 shows the cascade connection of basic cells of the group delay line network in accordance with the present invention.

### DETAILED DESCRIPTION OF THE PREFERRED EMBODIMENT

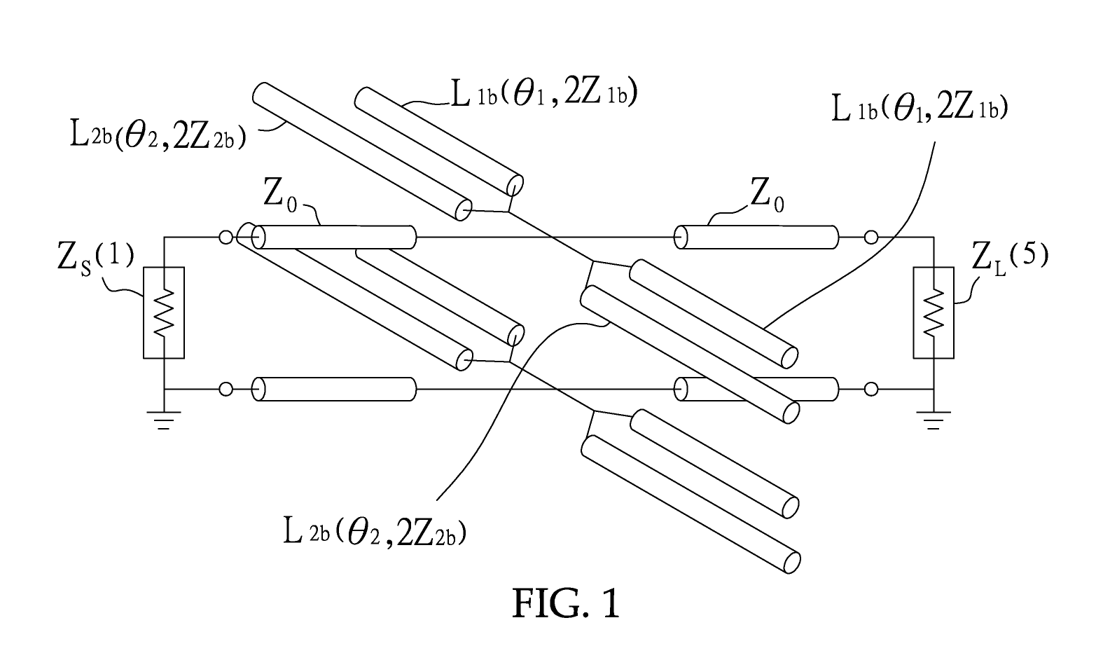

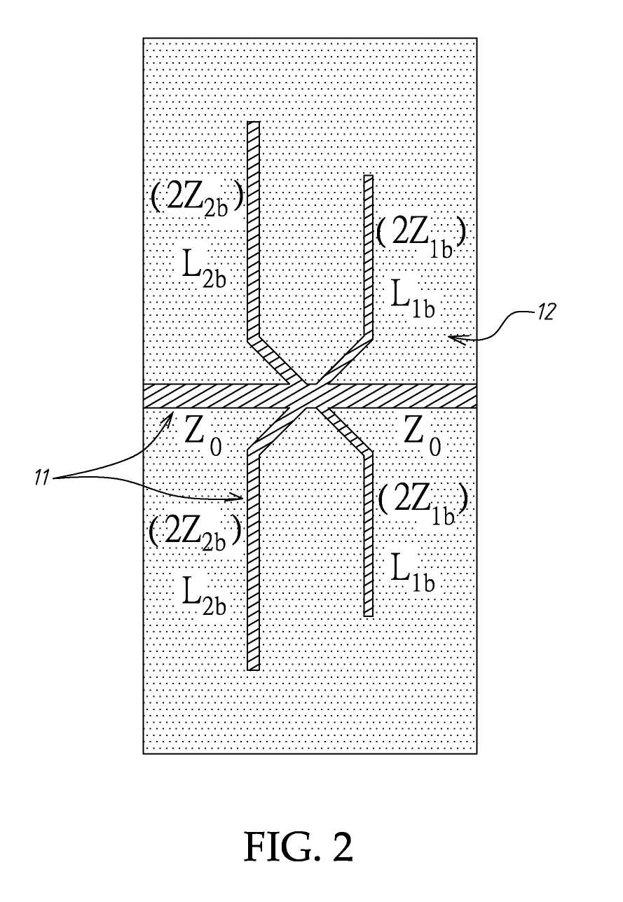

To appreciate the details of the present invention, a general understanding of transmission lines will prove helpful. In this regard, reference should be made to FIG. 1 for the basic cell of the group delay line, where (the drawing is a conventional, prior to art transmission line,) 2Z_{1b} (i=1, 2) is the characteristic impedance, β_{ib} is the propagation constant, and l_{ib} is the physical length of transmission line. The electric lengths of open stubs 2Z_{1b} and 2Z_{2b} are unequal, i.e., θ₁=β_{1b}l_{1b}≠β2l_{2b}=θ₂, or l_{1b}≠l_{2b} when β_{1b}=β_{2b}. The lengths L_{1b} and L_{2b} in FIG. 2 are used to represent l_{1b} and l_{2b}, respectively. In the following discussion, the equivalent characteristic impedance of parallel stubs (2Z_{ib}, 2Z_{ib}) is changed to Z_{ib} so as to simplify the mathematical representation.

Notice that a microstrip structure has a signal layer and a ground layer, while a stripline structure has a signal layer and two ground layers. The following discussion using transmission-line representation is suitable for both microstrip structure and stripline structure.

The input impedance Z_{in,i} looking from the main line Z₀ toward each of the open stub is

Z_{in,i}=−jZᵢ cot (β_{ib}l_{ib}), (i=1,2). (3)

When one of the physical lengths l_{ib} is equal to a quarter guided wavelength, the input impedance Z_{in,i} is zero. As a result, a transmission zero occurs. When the open stub is smaller than a quarter guided wave-length, the open stub appears to be capacitive. On the other hand, if the open stub is larger than a quarter guided wave-length, it is inductive. When two parallel stubs with different physical lengths are implemented, two transmission zeros occur at two respective frequencies. At a frequency located between two transmission-zero frequencies, one Z_{in,i} (i=1,2) is inductive and another is capacitive. When Z_{in,1}+Z_{in,2}=0, the total input impedance due to two parallel stubs is infinite, and a total transmission through the main line occurs. As a result, a pass-band is induced between two transmission nulls. The induced pass-band exhibits excessive group delay.

For the circuit shown in FIG. 1, the scattering parameter S₂₁ (or transmission coefficient) is as follows

$$\begin{matrix}{S}_{21} = [ \frac{2 {Z}_{in}}{{Z}_{in} + {Z}_{o}} ] , \\ where & ( 4 ) \\ {Z}_{in} = [ \frac{1}{\frac{1}{{Z}_{o}} + \frac{1}{{Z}_{in , 1}} + \frac{1}{{Z}_{in , 2}}} ] . & ( 5 )\end{matrix}$$

Substituting both (3) and (5) into (4), we obtain the transmission coefficient S₂₁

$${S}_{21} = \frac{1}{1 + j \frac{{Z}_{o} ( {Z}_{1 b} cot {θ}_{1} + {Z}_{2 b} {θ}_{2} )}{2 {Z}_{1 b} {Z}_{2 b} cot {θ}_{1} cot {θ}_{2}}} , \qquad ( 6 )$$

where θᵢβ_{ib}l_{ib} (i=1,2).

The complex scattering parameter S₂₁ can be expressed in the polar form as S₂₁=|S₂₁|<S₂₁. <S₂₁ is the argument of S₂₁ and it is given as follows

$${∠S}_{21} = - Π - {tan}^{- 1} [ \frac{{Z}_{o} ( {Z}_{1 b} cot {θ}_{1} + {Z}_{2 b} cot {θ}_{2} )}{2 {Z}_{1 b} {Z}_{2 b} cot {θ}_{1} cot {θ}_{2}} ] . \qquad ( 7 )$$

As stated in the above, an induced pass-band is lying between two transmission nulls caused by parallel stubs. The group delay G_{d} of the basic cell is defined as

$${G}_{d} = - \frac{d {∠S}_{21}}{d ϖ} , \qquad ( 8 )$$

where ω is the angular frequency of signal. The group delay G_{d} is determined by characteristic impedance Z_{ib} (i=1,2) , and electrical length θᵢ of transmission lines. Upon the substitution of (7) into (8), we obtain

$$\begin{matrix}{G}_{d} = \frac{{Z}_{o} {Z}_{1 b} {Z}_{2 b} \{ A - B \}}{2 {Z}_{1 b}^{2} {Z}_{2 b}^{2} {cot}^{2} {θ}_{1} {cot}^{2} {θ}_{2} + 2 {{Z}_{o}^{2} ( {Z}_{1 b} cot {θ}_{1} + {Z}_{2 b} cot {θ}_{2} )}^{2}} , \\ where & ( 9 ) \\ A = ( {Z}_{1 b} cot {θ}_{1} + {Z}_{2 b} cot {θ}_{2} ) [ \begin{matrix}( cot {θ}_{2} + {cot}^{2} {θ}_{1} cot {θ}_{2} ) {T}_{1} + \\ ( cot {θ}_{1} + {cot}^{2} {θ}_{2} cot {θ}_{1} ) {T}_{2}\end{matrix} ] , \\ and & ( 9 a ) \\ B = ( {Z}_{1 b} {T}_{1} + {T}_{2 b} {T}_{2} + {T}_{1 b} {T}_{1} {cot}^{2} {θ}_{1} + {Z}_{2 b} {T}_{2} {cot}^{2} {θ}_{2} ) cot {θ}_{1} cot {θ}_{2} . & ( 9 b )\end{matrix}$$

T₁ and T₂ in (9a) and (9b) are propagation delay time for signal traveling across lines l_{1b} and l_{2b}, respectively, i.e., dθᵢ/dω=Tᵢ (i=1,2). The maximum group delay occurs at the total transmission frequency. Substituting Z_{1b} cot θ₁+Z_{2b} cot θ₂=0 into (9), we obtain

$${G}_{d} = \frac{- {Z}_{o}}{2 {Z}_{1 b} {Z}_{2 b} cot {θ}_{1} cot {θ}_{2}} [ {Z}_{1 b} ( 1 + {cot}^{2} {θ}_{1} ) {T}_{1} + {Z}_{2 b} ( 1 + {cot}^{2} {θ}_{2} ) {T}_{2} ] . \qquad ( 10 )$$

To extract the physical insight regarding the maximum group delay of this dispersive transmission line, we further simplify its mathematical expressions. A transmission-zero frequency occurs when the physical length of a stub is a quarter guided wavelength. The electrical lengths of two stubs at the total-transmission frequency of induced pass-band can thus be set as follows

θ₁=π/2−δ₁, θ₂=π/2+δ₂. (11)

δᵢ (i=1,2) is the electrical length distance in radian between the electrical length at the total transmission frequency of induced pass-band and the electrical length at the transmission null frequency caused by the respective stub. If it is assumed that δ₁=δ₂=δ, (10) is further simplified to the following

$${G}_{d} = \frac{{Z}_{o} [ ( {Z}_{1 b} {T}_{2} + {T}_{2 b} {T}_{1} ) ( 1 + {tan}^{2} δ ) ]}{2 {Z}_{1 b} {Z}_{2 b} {tan}^{2} δ} . \qquad ( 12 )$$

For a narrow, induced pass-band, we have tan δ=δ and tan² δ<<1. Under such a condition, the group delay G_{d} in (12) now becomes as follows

$${G}_{d} \approx \frac{{Z}_{o}}{2 {Z}_{1 b} {Z}_{2 b} {δ}^{2}} [ {Z}_{1 b} {T}_{1} + {Z}_{2 b} {T}_{2} ] . \qquad ( 13 )$$

Notice that Tᵢ (i=1, 2) is the propagation delay time for the signal traveling across the stub line. If we assume that δ₁=δ₂=δ₀/2 and T₁=T₂=T₀, (13) can be simplified further to the following

$${G}_{d , narrowband} \approx 2 {T}_{o} \frac{{Z}_{o}}{{Z}_{1 b} {Z}_{2 b} / ( {Z}_{1 b} + {Z}_{2 b} )} \frac{1}{{δ}_{o}^{2}} , \qquad ( 14 )$$

where T₀ is the propagation delay time across a quarter guided wavelength and δ₀ is the normalized bandwidth between two transmission nulls caused by two stubs.

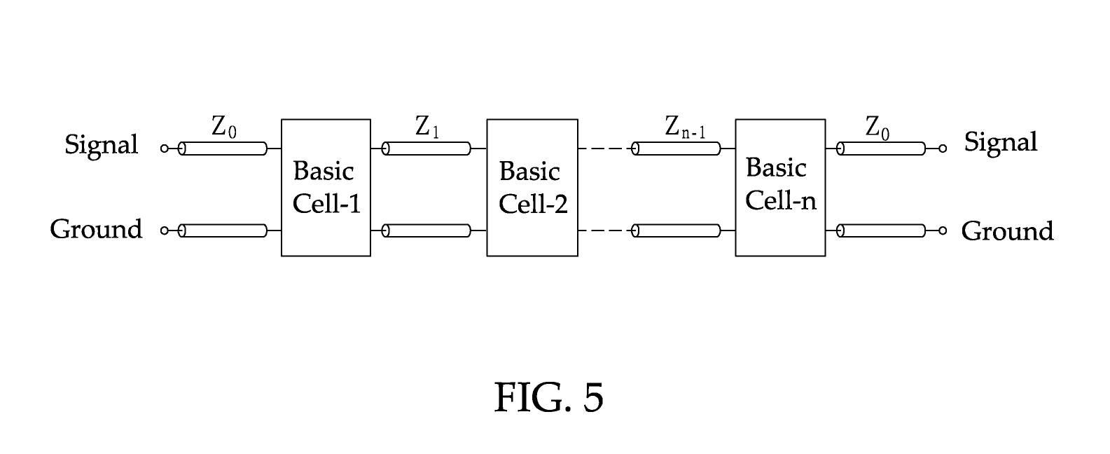

As shown in FIG. 5, a cascade connection of the basic cells using segments Z₁, Z₂, . . . , Zₙ (n is a positive integer) to form a group delay line system.

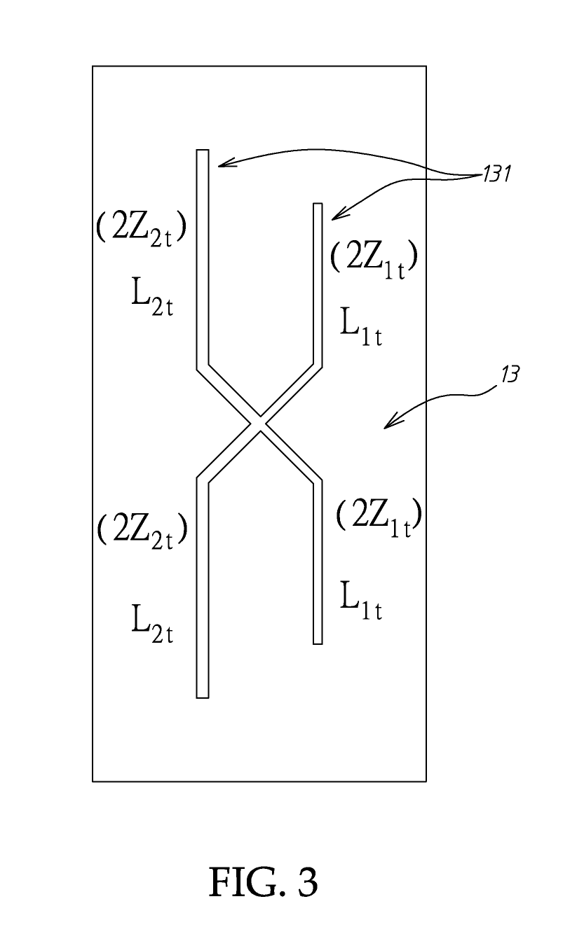

The introduction of complementary slot lines is to transform the induced, band-limited pass-band to an all pass-band, which is |S₂₁|=1. L₁ₜ and L₂ₜ in FIG. 3 are the lengths of complementary slot lines 2Z₁ₜ and 2Z₂ₜ, respectively.

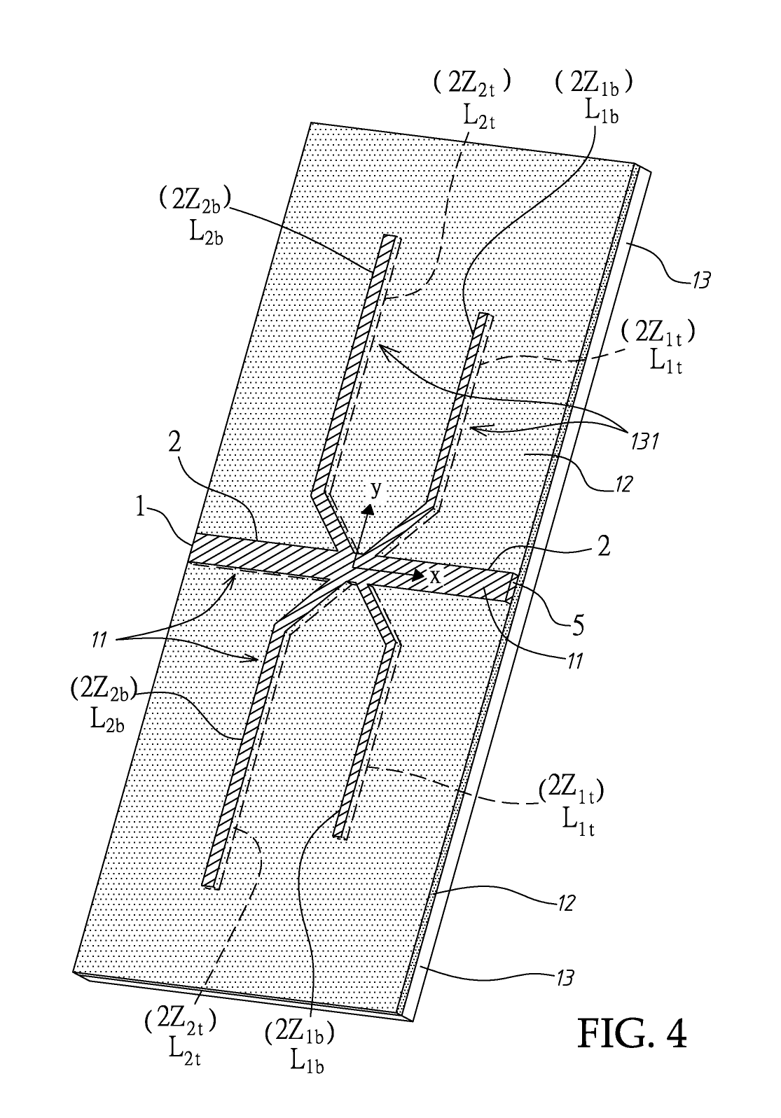

The three-dimension schematic drawing of basic cell of a group delay line in FIG. 4 is a three-layers structure, where (11) is the signal (top) layer, (12) is the insulating (middle) layer, and (13) is the conductor ground (bottom) layer.

What is claimed is:

1. A basic cell for tuning the signal propagation delay time from the source end (1) to the output load (5), consisting a main signal transmission path (2) for the input signal and output signal, two pairs of unequal-length, open stubs ((L_{1b}, L_{1b}), (L_{2b}, L_{2b})) placed on two sides of the main signal transmission path that form an induced pass-band, two pairs of unequal-length, complementary slot lines ((L₁ₜ, L₁ₜ), (L₂ₜ, L₂ₜ)) that are placed in the ground plane for the microstrip structure.

2. The basic cell according to claim 1, wherein each open stub is uniform, non-uniform or meandered along the line and each complementary slot line is uniform, non-uniform or meandered.

3. The basic cell according to claim 1, wherein each open stub is implemented in multiple layers and each complementary slot line is implemented in multiple layers.

4. The basic cell according to claims 1, where the characteristic impedances Z_{1b}, Z_{2b} with electrical lengths θ₁ , θ₂ (θ₁≠θ₂) of shunt open stubs satisfy:
Z_{1b} cot θ₁+Z_{2b} cot θ₂=0
in the operating frequency band.

5. The basic cell according to claims 1, wherein main transmission path (2) and open stubs ((L_{1b}, L_{1b}), (L_{2b}, L_{2b})) are conductor printed wires in the signal layer (11) of a printed circuit board, complementary slot lines ((L₁ₜ, L₁ₜ), (L₂ₜ, L₂ₜ)) are line areas in the ground plane (13) where metal conductor is removed.

6. The basic cell according to claims 1, wherein a cascade connection of the basic cells using segments Z₁, Z₂, . . . , Zₙ (n is a positive integer) to form a group delay line system.

7. A basic cell consisting of multiple pairs of open stubs and multiple pairs of complementary slot lines, wherein open stubs ((L_{1b}, L_{1b}), . . . , (L_{nb}, L_{nb})) (n is a positive integer) are printed conductor wires in the signal layer of a printed circuit board, complementary slot lines ((L₁ₜ, L₁ₜ), . . . , (Lₙₜ, Lₙₜ) are line areas in the ground planes, where the conductor is removed.

8. A basic cell for tuning the signal propagation delay time from the source end (1) to the output load (5), consisting a main signal transmission path (2) for the input signal and output signal, two pairs of unequal-length, open stubs ((L_{1b}, L_{1b}), (L_{2b}, L_{2b})) placed on two sides of the main signal transmission path that form an induced pass-band, two pairs of unequal-length, complementary slot lines ((L₁ₜ, L₁ₜ), (L₂ₜ, L₂ₜ)) that are placed in either the outer ground planes for the strip-line structure.
